(19) United States
(12) Patent Application Publication
(10) Pub. No.: US 2006/0247148 A1
(43) Pub. Date: Nov. 2, 2006

(54) Laundry detergents containing mid-branched primary alkyl sulfate surfactant

(76) Inventors: Rafael Ortiz, Milford, OH (US); Rajan Keshav Panandiker, West Chester, OH (US); Fredric Barton Rea, Lawrenceburg, IN (US); Nicholas David Vetter, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/401,000

(22) Filed: Apr. 10, 2006

Related U.S. Application Data
(60) Provisional application No. 60/671,907, filed on Apr. 15, 2005.

(51) Int. Cl. C11D 17/00

(52) U.S. Cl. 510/424

(57) ABSTRACT

Liquid laundry detergent compositions having improved stability and viscosity, and containing from about 5% to about 20%, by weight of the composition, of a surfactant system. The surfactant system contains from about 0.5% to about 15%, by weight of the composition, of a mid-branched primary alkyl sulfate surfactant having an average of from about 14 to about 17 total carbons; at least about 0.1%, by weight of the composition, of an additional surfactant selected from alkyl alkoxy sulfate surfactants, alkyl alkoxy surfactants, and mixtures thereof; and from about 0.1% to about 1.5%, by weight of the composition, of sodium formate. The liquid laundry compositions contain less than about 3% of HLAS surfactants.

### CROSS REFERENCE TO RELATED APPLICATION

This application claims the benefit of priority to U.S. Provisional Application Ser. No. 60/671,907, filed Apr. 15, 2005 (P&G Case No. 9966P).

### FIELD OF THE INVENTION

The present invention describes liquid laundry detergent compositions comprising a mixture of surfactants consisting of mid-chain branched primary alkyl sulfate, sodium alkyl ether sulfate and/or alkyl ethoxy surfactants with improved viscosity, good cleaning and good stability properties.

### BACKGROUND OF THE INVENTION

Liquid laundry detergent products are well known, with a variety of products available to the consumer. It is known that many consumers are selective in their choices of laundry detergent based upon cost. Therefore, laundry detergent manufacturers consistently develop new ways to reduce the costs associated with providing laundry detergents to consumers that are reasonably priced. As the cost of surfactants increases due to raw materials cost, manufacturers are faced with even more challenges in maintaining the cost structure for liquid laundry detergents. One of the easiest ways to reduce the cost associated with liquid laundry detergent products is to reduce the levels of the more expensive surfactants and viscosity modifying ingredients. However, by reducing the amount of surfactants, the cleaning efficacy of the formulation may be significantly reduced. Even where the cleaning efficacy can be solved by other means, there still often exists a problem in that the viscosity of the formulation is often dramatically reduced. Although to some extent, the viscosity can be raised with the addition of viscosity modifiers, this is often undesirable due to cost or other formulation stability/interaction issues.

Consumers often find viscosity to be an important physical property of liquid detergent formulations. For example, the consumer acceptance of clear isotropic liquid laundry detergent formulations is often highly dependent on product viscosity. In cases where the liquid detergent formulations have low viscosity, the consumer may have the perception that the product will not be effective at removing soils and stains from fabrics in the laundering process. It is also well known to those skilled in the art that liquid formulations comprising surfactant mixtures with high levels of the hydrophobic linear alkyl benzene sulfonate (HLAS) surfactant have low viscosity. The viscosity of such formulations can be increased by addition of electrolytes like sodium formate. However, addition of sodium formate increases viscosity up to a point and then plateaus. Furthermore, addition of sodium formate, especially high levels, results in overall high ionic strength and together with high levels of the hydrophobic sodium linear alkyl benzene sulfonates many times leads to unstable formulations and to phase separation or precipitate formation. Yet another disadvantage of liquid surfactant formulations containing high levels of HLAS surfactant is the need to add high levels of solvent and hydrotrope to stabilize the formulation which then leads to higher chemical cost. As mentioned above, addition of a viscosity modifier (thickening agent) to such formulations will fix the problem but this also increases formulation cost.

Therefore, it clearly can be seen that although many different types of formulations are known for use in liquid laundry detergent products, determining the right surfactants in combination with the right additional materials is still a difficult task.

Accordingly, need exists for improved liquid laundry detergent formulations that provide good cleaning efficacy, good stability, and desirable viscosity, all at a reasonable cost.

### SUMMARY OF THE INVENTION

The compositions of the present invention include a surfactant system, sodium formate, have a viscosity of about 300 to about 400 cps and have low amounts (less than 3%), or are substantially free of HLAS. The compositions further have a hydrophilic index from about 7 to about 10.5. Compositions according to the present invention are described in further detail below.

Generally, the invention is directed to liquid laundry detergent compositions having improved stability and viscosity. The compositions contain from about 5% to about 20%, by weight of the composition, of a surfactant system, wherein the surfactant system comprises; from about 0.5% to about 15%, by weight of the composition, of a mid-branched primary alkyl sulfate surfactant having an average of from about 14 to about 17 total carbons; at least about 0.1%, by weight of the composition, of an additional surfactant selected from alkyl alkoxy sulfate surfactants, alkyl alkoxy surfactants, and mixtures thereof; and from about 0.1% to about 1.5%, by weight of the composition, of sodium formate. The compositions contain less than about 3% of HLAS surfactants.

Another aspect of the invention provides liquid laundry detergent compositions having improved stability and viscosity, wherein the compositions contain from about 5% to about 20%, by weight of the composition, of a surfactant system, wherein the surfactant system contains; from about 0.5% to about 15%, by weight of the composition, of a mid-branched primary alkyl sulfate surfactant selected from 3-methyl pentadecanol sulfate, 4-methyl pentadecanol sulfate, 5-methyl pentadecanol sulfate, 6-methyl pentadecanol sulfate, 7-methyl pentadecanol sulfate, 8-methyl pentadecanol sulfate, 9-methyl pentadecanol sulfate, 10-methyl pentadecanol sulfate, 11-methyl pentadecanol sulfate, 12-methyl pentadecanol sulfate, 13-methyl pentadecanol sulfate, 3-methyl hexadecanol sulfate, 4-methyl hexadecanol sulfate, 5-methyl hexadecanol sulfate, 6-methyl hexadecanol sulfate, 7-methyl hexadecanol sulfate, 8-methyl hexadecanol sulfate, 9-methyl hexadecanol sulfate, 10-methyl hexadecanol sulfate, 11-methyl hexadecanol sulfate, 12-methyl hexadecanol sulfate, 13-methyl hexadecanol sulfate, 14-methyl hexadecanol sulfate, 2,3-methyl tetradecanol sulfate, 2,4-methyl tetradecanol sulfate, 2,5-methyl tetradecanol sulfate, 2,6-methyl tetradecanol sulfate, 2,7-methyl tetradecanol sulfate, 2,8-methyl tetradecanol sulfate, 2,9-methyl tetradecanol sulfate, 2,10-methyl tetradecanol sulfate, 2,11-methyl tetradecanol sulfate, 2,12-methyl tetradecanol sulfate, 2,3-methyl pentadecanol sulfate, 2,4-methyl pentadecanol sulfate, 2,5-methyl pentadecanol sulfate, 2,6-methyl pentadecanol sulfate, 2,7-methyl pentadecanol sulfate, 2,8-methyl pentadecanol sulfate, 2,9-methyl pentadecanol sulfate, 2,10-methyl pentadecanol sulfate, 2,11-methyl pentadecanol sulfate, 2,12-methyl pentadecanol sulfate, 2,13-methyl pentadecanol sulfate, and mixtures thereof; at least about 0.1%, by weight of the composition, of an additional surfactant selected from alkyl alkoxy sulfate surfactants, alkyl alkoxy surfactants, and mixtures thereof; and from about 0.1% to about 1.5%, by weight of the composition, of sodium formate; wherein the composition is substantially free of HLAS surfactants.

In further embodiments, the invention is directed to such compositions wherein the composition contains from about 0.1% to about 10%, by weight of the composition, of alkyl alkoxy surfactant.

In further embodiments, the invention is directed to such compositions wherein the composition contains from about 0.5% to about 15%, by weight of the composition of an alkyl alkoxy sulfate surfactant.

In further embodiments, the invention is directed to such compositions wherein the composition is substantially free of APA;

In further embodiments, the invention is directed to such compositions wherein the composition further contains less than about 2.5% builders, in one embodiment less than about 2.5% citric acid.

In further embodiments, the invention is directed to such compositions wherein the composition has a viscosity of from about 300 to about 400 centipoise.

In further embodiments, the invention is directed to such compositions wherein the composition has a hydrophilic index of from about 7 to about 10.5.

In further embodiments, the invention is directed to such compositions wherein the composition further contains an aqueous component, in one embodiment, from about 5% to about 90%, by weight of the composition, of water.

In further embodiments, the invention is directed to such compositions wherein the mid-branched primary alkyl sulfate surfactant is selected from: 3-methyl pentadecanol sulfate, 4-methyl pentadecanol sulfate, 5-methyl pentadecanol sulfate, 6-methyl pentadecanol sulfate, 7-methyl pentadecanol sulfate, 8-methyl pentadecanol sulfate, 9-methyl pentadecanol sulfate, 10-methyl pentadecanol sulfate, 11-methyl pentadecanol sulfate, 12-methyl pentadecanol sulfate, 13-methyl pentadecanol sulfate, 3-methyl hexadecanol sulfate, 4-methyl hexadecanol sulfate, 5-methyl hexadecanol sulfate, 6-methyl hexadecanol sulfate, 7-methyl hexadecanol sulfate, 8-methyl hexadecanol sulfate, 9-methyl hexadecanol sulfate, 10-methyl hexadecanol sulfate, 11-methyl hexadecanol sulfate, 12-methyl hexadecanol sulfate, 13-methyl hexadecanol sulfate, 14-methyl hexadecanol sulfate, 2,3-methyl tetradecanol sulfate, 2,4-methyl tetradecanol sulfate, 2,5-methyl tetradecanol sulfate, 2,6-methyl tetradecanol sulfate, 2,7-methyl tetradecanol sulfate, 2,8-methyl tetradecanol sulfate, 2,9-methyl tetradecanol sulfate, 2,10-methyl tetradecanol sulfate, 2,11-methyl tetradecanol sulfate, 2,12-methyl tetradecanol sulfate, 2,3-methyl pentadecanol sulfate, 2,4-methyl pentadecanol sulfate, 2,5-methyl pentadecanol sulfate, 2,6-methyl pentadecanol sulfate, 2,7-methyl pentadecanol sulfate, 2,8-methyl pentadecanol sulfate, 2,9-methyl pentadecanol sulfate, 2,10-methyl pentadecanol sulfate, 2,11-methyl pentadecanol sulfate, 2,12-methyl pentadecanol sulfate, 2,13-methyl pentadecanol sulfate, and mixtures thereof.

In further embodiments, the invention is directed to such compositions wherein the mid-branched primary alkyl sulfate surfactant is selected from:

5-methylpentadecylsulfate having the formula:

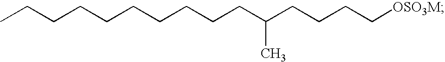

6-methylpentadecylsulfate having the formula

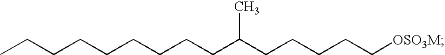

7-methylpentadecylsulfate having the formula

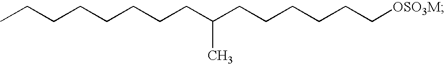

8-methylpentadecylsulfate having the formula

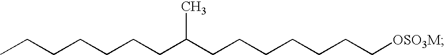

9-methylpentadecylsulfate having the formula

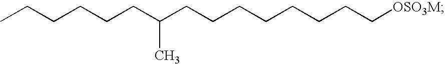

10-methylpentadecylsulfate having the formula

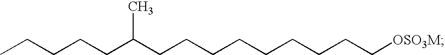

2,5-dimethylpentadecylsulfate having the formula:

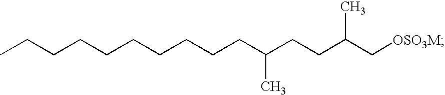

2,6-dimethylpentadecylsulfate having the formula

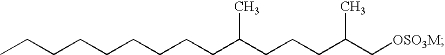

2,7-dimethylpentadecylsulfate having the formula

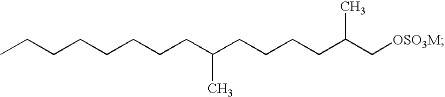

2,8-dimethylpentadecylsulfate having the formula

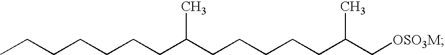

2,9-dimethylpentadecylsulfate having the formula

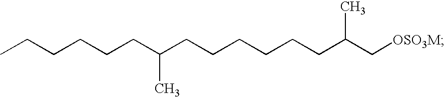

2,10-dimethylpentadecylsulfate having the formula 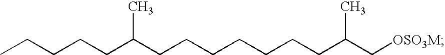
and mixtures thereof; wherein M is sodium.

In further embodiments, the invention is directed to such compositions wherein the composition contains from about from about 0.1% to about 10%, by weight of the composition, of alkyl alkoxy surfactant and from about 0.5% to about 15%, by weight of the composition, of an alkyl alkoxy sulfate surfactant.

The compositions and methods of the present invention are advantageous in providing improved viscosity, while maintaining good cleaning and good stability. Additional objects and advantages will be apparent in view of the detailed description of the invention.

These and other features, aspects, and advantages of the present invention will become evident to those skilled in the art from a reading of the present disclosure.

### DETAILED DESCRIPTION OF THE INVENTION

The laundry detergent compositions of the present invention are generally in liquid form. In one embodiment, the compositions are liquid in form and comprise heavy duty liquid compositions.

All percentages and ratios used herein are by weight of the total composition and all measurements made are at 25° C., unless otherwise designated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the liquid laundry detergent compositions of the present invention, unless otherwise specified. All such weights as they pertain to listed ingredients are based on the active level and, therefore, do not include carriers or by-products that may be included in commercially available materials, unless otherwise specified.

It has now been found that liquid laundry detergent compositions containing from about 5% to about 20% of a surfactant system, where the surfactant system contains about 0.5% to about 15%, by weight of the composition, of a mid-branched primary alkyl sulfate surfactant having an average of from about 14 to about 17 total carbons in combination with at least about 0.1%, by weight of the composition, of an additional surfactant selected from alkyl alkoxy sulfate surfactants and alkyl alkoxy surfactants, and mixtures thereof and from about 0.1% to about 1.5%, by weight of the composition, of sodium formate are useful for providing improved viscosity in a cost-effective formulation with good cleaning and good stability where the compositions contain less than 3%, by weight of the composition, of HLAS surfactants.

The compositions herein may also include a wide variety of other ingredients. The compositions of the present invention, are described in detail hereinafter.

While the specification concludes with the claims particularly pointing and distinctly claiming the invention, it is believed that the present invention will be better understood from the following description.

Surfactant System

The liquid laundry detergent compositions of the present invention contain from about 5% to about 20%, by weight of the composition, of a surfactant system. The surfactant system contains a mid-branched primary alkyl sulfate surfactant in combination with an alkyl alkoxy sulfate surfactant and/or alkyl alkoxy surfactant. The surfactant system contains less than 3% HLAS and is, in one embodiment, substantially free of APA.

Mid-Branched Primary Alkyl Sulfate Surfactants

The compositions of the present invention contain from about 0.5% to about 15%, by weight of the composition, of a mid-branched primary alkyl sulfate surfactant having an average of from about 14 to 17 total carbons. Alternatively the composition may contain from about from about 2% to about 12%, alternatively from about 5% to about 10%, by weight of the composition, of a mid-branched primary alkyl sulfate surfactant having an average carbon chain length of from about 14 to about 17. Examples of mid-branched primary alkyl sulfate surfactants useful herein are discussed in more detail below.

The branched surfactant compositions comprise mid-chain branched primary alkyl sulfate surfactants having the formula 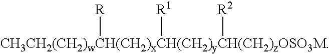
Generally, the branched surfactant component will contain a mixtures of at least two mid-chain branched primary alkyl surfactants. In one embodiment, the branched surfactant component will also contain a number of other surfactant materials and similar by-products that are present due to the production procedures of such materials. This would be understood by one of ordinary skill in the area of mid-branched primary alkyl surfactants.

The surfactant mixtures of the present invention comprise molecules having a linear primary alkyl sulfate chain backbone (i.e., the longest linear carbon chain which includes the sulfated carbon atom). These alkyl chain backbones comprise from about 6 to about 16 carbon atoms, alternatively from about 14 to about 16 carbon atoms; and further the molecules comprise a branched primary alkyl moiety having at least a total of about 14, but not more than about 17, carbon atoms. In addition, the surfactant mixture has an average total number of carbon atoms for the branched primary alkyl moieties within the range of from greater than 14 to about 17. Thus, the present invention mixtures comprise at least one branched primary alkyl sulfate surfactant compound having a longest linear carbon chain of not less than 14 carbon atoms or more than 16 carbon atoms.

For example, a C16 total carbon primary alkyl sulfate surfactant having 13 carbon atoms in the backbone must have 1, 2, or 3 branching units (i.e., R, R¹ and/or R³) whereby total number of carbon atoms in the molecule is at least 16. In this example, the C16 total carbon requirement may be satisfied equally by having, for example, one propyl branching unit or three methyl branching units.

R, R¹, and R² are each independently selected from hydrogen and C₁-C₃ alkyl (alternatively from hydrogen or C₁-C₂ alkyl, alternatively from hydrogen or methyl, and in one embodiment, are methyl groups), provided R, R¹, and R² are not all hydrogen. Further, when z is 1, at least R or R¹ is not hydrogen.

Although for the purposes of the present invention surfactant compositions the above formula does not include molecules wherein the units R, R¹, and R² are all hydrogen (i.e., linear non-branched primary alkyl sulfates), it is to be recognized that the present invention compositions may still further comprise some amount of linear, non-branched primary alkyl sulfate. Further, this linear non-branched primary alkyl sulfate surfactant may be present as the result of the process used to manufacture the surfactant mixture having the requisite one or more mid-chain branched primary alkyl sulfates according to the present invention, or for purposes of formulating detergent compositions some amount of linear non-branched primary alkyl sulfate may be admixed into the final product formulation.

Further it is to be similarly recognized that non-sulfated mid-chain branched alcohol may comprise some amount of the present invention compositions. Such materials may be present as the result of incomplete sulfation of the alcohol used to prepare the alkyl sulfate surfactant, or these alcohols may be separately added to the present invention detergent compositions along with a mid-chain branched alkyl sulfate surfactant according to the present invention.

M is hydrogen or a salt forming cation depending upon the method of synthesis. Examples of salt forming cations are lithium, sodium, potassium, calcium, magnesium, quaternary alkyl amines having the formula 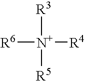
wherein R³, R⁴, R⁵ and R⁶ are independently hydrogen, C₁-C₂₂ alkylene, C₄-C₂₂ branched alkylene, C₁-C₆ alkanol, C₁-C₂₂ alkenylene, C₄-C₂₂ branched alkenylene, and mixtures thereof. Preferred cations are ammonium (R³, R⁴, R⁵ and R⁶ equal hydrogen), sodium, potassium, mono-, di-, and trialkanol ammonium, and mixtures thereof. The monoalkanol ammonium compounds of the present invention have R³ equal to C₁-C₆ alkanol, R⁴, R⁵ and R⁶ equal to hydrogen; dialkanol ammonium compounds of the present invention have R³ and R⁴ equal to C₁-C₆ alkanol, R⁵ and R⁶ equal to hydrogen; trialkanol ammonium compounds of the present invention have R³, R⁴ and R⁵ equal to C₁-C₆ alkanol, R⁶ equal to hydrogen. Preferred alkanol ammonium salts of the present invention are the mono-, di- and tri-quaternary ammonium compounds having the formulas:
H₃N⁺CH₂CH₂OH, H₂N⁺(CH₂CH₂OH)₂, HN⁺(CH₂CH₂OH)₃.
Preferred M is sodium, potassium and the C₂ alkanol ammonium salts listed above; most preferred is sodium.

Further regarding the above formula, w is an integer from 0 to 7; x is an integer from 0 to 7; y is an integer from 0 to 7; z is an integer of at least 1; and w+x+y+z is a integer from 1 to 11, alternatively from 7 to 10.

Certain points of branching (i.e., the location along the chain of the R, R¹, and/or R² moieties in the above formula) are preferred over other points of branching along the backbone of the surfactant. The formula below illustrates the mid-chain branching range (i.e., where points of branching occur), preferred mid-chain branching range, and more preferred mid-chain branching range for mono-methyl substituted linear alkyl sulfates of the present invention. 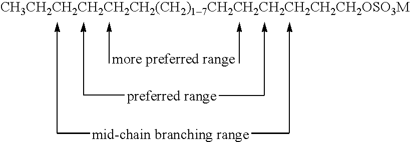
It should be noted that for the mono-methyl substituted surfactants these ranges exclude the two terminal carbon atoms of the chain and the two carbon atoms immediately adjacent to the sulfate group. For surfactant mixtures comprising two or more of R, R¹, or R², alkyl branching at the 2-carbon atom is within the scope of the present invention. Surfactants having chains longer than ethyl (i.e. C₃ alkyl substitutents) on the 2-carbon atom, however, are less preferred.

The formula below illustrates the mid-chain branching range, preferred mid-chain branching range, and more preferred mid-chain branching range for di-methyl substituted linear alkyl sulfates of the present invention. 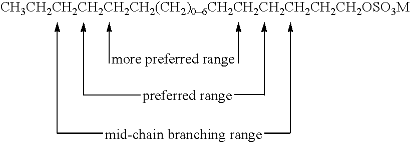
When di-alkyl substituted primary alkyl sulfates are combined with mono-substituted mid-chain branched primary alkyl sulfates, the di-alkyl substituted primary alkyl sulfates having one methyl substitution on the 2-carbon position and another methyl substitution in the preferred range as indicated above, are within the present invention.

The preferred surfactant mixtures of the present invention have at least 0.001%, more preferably at least 5%, most preferably at least 20% by weight, of the mixture one or more branched primary alkyl sulfates having the formula 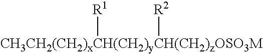
wherein the total number of carbon atoms, including branching, is from 14 to 17, and wherein further for this surfactant mixture the average total number of carbon atoms in the branched primary alkyl moieties having the above formula is within the range of greater than 14 to about 17; R¹ and R² are each independently hydrogen or C₁-C₃ alkyl; M is a water soluble cation; x is from 0 to 7; y is from 0 to 7; z is at least 2; and x+y+z is from 2 to 10; provided R¹ and R² are not both hydrogen. More preferred are compositions having at least 5% of the mixture comprising one or more mid-chain branched primary alkyl sulfates wherein x+y is equal to 9 or 10 and z is 2.

Preferred novel mid-chain branched primary alkyl sulfate compounds have the formula: 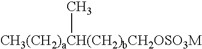
wherein: a and b are integers and a+b is 12 or 13, a is an integer from 2 to 11, b is an integer from 1 to 10 and M is selected from sodium, potassium, ammonium and substituted ammonium. More preferred embodiments of such compounds include an alkyl sulfate compound of said formula wherein M is selected from sodium, potassium and ammonium.

Also preferred novel mid-chain branched primary alkyl sulfate compounds have the formula: 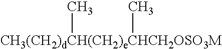
wherein:
d and e are integers and d+e is 10 or 11; and wherein further
when d+e=10, d is an integer from 2 to 9 and e is an integer from 1 to 8;
when d+e=11, d is an integer from 2 to 10 and e is an integer from 1 to 9;
and M is selected from sodium, potassium, ammonium and substituted ammonium, more preferably sodium, potassium and ammonium, most preferably sodium.

Preferred mono-methyl branched primary alkyl sulfates are selected from the group consisting of: 3-methyl pentadecanol sulfate, 4-methyl pentadecanol sulfate, 5-methyl pentadecanol sulfate, 6-methyl pentadecanol sulfate, 7-methyl pentadecanol sulfate, 8-methyl pentadecanol sulfate, 9-methyl pentadecanol sulfate, 10-methyl pentadecanol sulfate, 11-methyl pentadecanol sulfate, 12-methyl pentadecanol sulfate, 13-methyl pentadecanol sulfate, 3-methyl hexadecanol sulfate, 4-methyl hexadecanol sulfate, 5-methyl hexadecanol sulfate, 6-methyl hexadecanol sulfate, 7-methyl hexadecanol sulfate, 8-methyl hexadecanol sulfate, 9-methyl hexadecanol sulfate, 10-methyl hexadecanol sulfate, 11-methyl hexadecanol sulfate, 12-methyl hexadecanol sulfate, 13-methyl hexadecanol sulfate, 14-methyl hexadecanol sulfate, and mixtures thereof.

Preferred di-methyl branched primary alkyl sulfates are selected from the group consisting of: 2,3-methyl tetradecanol sulfate, 2,4-methyl tetradecanol sulfate, 2,5-methyl tetradecanol sulfate, 2,6-methyl tetradecanol sulfate, 2,7-methyl tetradecanol sulfate, 2,8-methyl tetradecanol sulfate, 2,9-methyl tetradecanol sulfate, 2,10-methyl tetradecanol sulfate, 2,11-methyl tetradecanol sulfate, 2,12-methyl tetradecanol sulfate, 2,3-methyl pentadecanol sulfate, 2,4-methyl pentadecanol sulfate, 2,5-methyl pentadecanol sulfate, 2,6-methyl pentadecanol sulfate, 2,7-methyl pentadecanol sulfate, 2,8-methyl pentadecanol sulfate, 2,9-methyl pentadecanol sulfate, 2,10-methyl pentadecanol sulfate, 2,11-methyl pentadecanol sulfate, 2,12-methyl pentadecanol sulfate, 2,13-methyl pentadecanol sulfate, and mixtures thereof.

The following branched primary alkyl sulfates comprising 16 carbon atoms and having one branching unit are examples of preferred branched surfactants useful in the present invention compositions:

5-methylpentadecylsulfate having the formula:

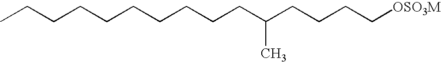

6-methylpentadecylsulfate having the formula

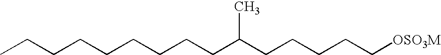

7-methylpentadecylsulfate having the formula

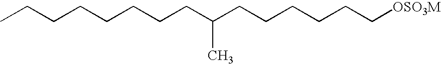

8-methylpentadecylsulfate having the formula

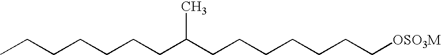

9-methylpentadecylsulfate having the formula

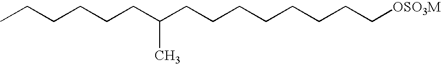

10-methylpentadecylsulfate having the formula

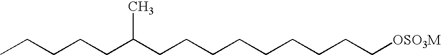

wherein M is preferably sodium.

The following branched primary alkyl sulfates comprising 17 carbon atoms and having two branching units are examples of preferred branched surfactants according to the present invention:

2,5-dimethylpentadecylsulfate having the formula:

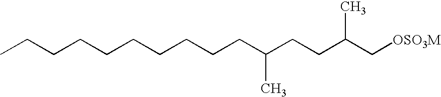

2,6-dimethylpentadecylsulfate having the formula

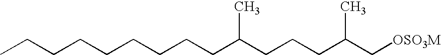

2,7-dimethylpentadecylsulfate having the formula

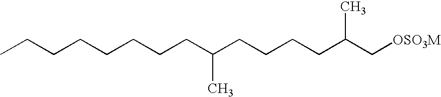

2,8-dimethylpentadecylsulfate having the formula

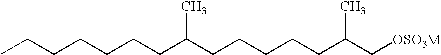

2,9-dimethylpentadecylsulfate having the formula

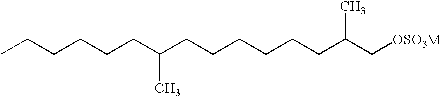

2,10-dimethylpentadecylsulfate having the formula

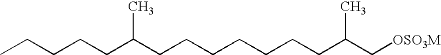

wherein M is preferably sodium.

Additional Surfactant

The compositions of the present invention will contain at least about 0.1%, by weight of the composition, of an additional surfactant which is selected from alkyl alkoxy sulfate surfactants, alkyl alkoxy surfactants, and mixtures thereof.

a) Alkyl Alkoxy Sulfate Surfactant

The additional surfactant may from about 0.5% to about 15%, by weight of the composition, of an alkyl alkoxy sulfate. The alkyl ethoxy sulfate surfactants useful herein include water soluble salts and/or acids of the formula RO(A)ₘSO₃M wherein R is an unsubstituted C₁₀-C₂₄ alkyl or hydroxyalkyl group having a C₁₀-C₂₄ alkyl component, alternatively a C₁₂-C₁₈ alkyl or hydroxyalkyl, alternatively a C₁₂-C₁₅ alkyl or hydroxyalkyl. A is an ethoxy or propoxy unit, m is greater than zero, typically between about 0.5 and about 6, alternatively between about 0.5 and about 3, and M is H or a cation which can be, for example, a metal cation (e.g., sodium, potassium, lithium, calcium, magnesium, etc.), ammonium and/or substituted-ammonium cation. Alkyl ethoxylated sulfates as well as alkyl propoxylated sulfates are useful herein. Examples of substituted ammonium cations include ethanol-, triethanol-, methyl-, dimethyl, trimethyl-ammonium cations and quaternary ammonium cations such as tetramethyl-ammonium and dimethyl piperidinium cations and those derived from alkylamines such as ethylamine, diethylamine, triethylamine, mixtures thereof, and the like. Alkyl alkoxylated sulfate surfactants useful herein include C₁₂-C₁₅ alkyl polyethoxylate (1.0) sulfate (C₁₂-C₁₅E(1.0)M); C₁₂-C₁₅ alkyl polyethoxylate (2.25) sulfate (C₁₂-C₁₅E(2.25)M); C₁₂-C₁₅ alkyl polyethoxylate (3.0) sulfate (C₁₂-C₁₅E(3.0)M); C₁₂-C₁₅ alkyl polyethoxylate (4.0) sulfate (C₁₂-C₁₅E(4.0)M), wherein M is conveniently selected from sodium and potassium; and mixtures thereof.

b) Alkyl Alkoxy Surfactant

The additional surfactant may be from about 0.1% to about 10% by weight of the composition of nonionic surfactant that is an alkyl alkoxy surfactant.

Examples of alkyl alkoxy surfactants useful herein (typically at levels from about 0.1% to about 10%, by weight of the composition) include the alkoxylated alcohols (AE's) and alkyl phenols, polyhydroxy fatty acid amides (PFAA's), alkyl polyglycosides (APG's), C₁₀-C₁₈ glycerol ethers, and mixtures thereof

More specifically, the condensation products of primary and secondary aliphatic alcohols with from about 1 to about 25 moles of ethylene oxide (AE) are suitable for use as the alkyl alkoxy surfactant in the present invention. The alkyl chain of the aliphatic alcohol can either be straight or branched, primary or secondary, and generally contains from about 8 to about 22 carbon atoms. In one embodiment, the alkyl alkoxy surfactant is selected from the condensation products of alcohols having an alkyl group containing from about 8 to about 20 carbon atoms, more preferably from about 10 to about 18 carbon atoms, with from about 1 to about 10 moles, preferably 2 to 7, most preferably 2 to 5, of ethylene oxide per mole of alcohol. In one embodiment, the alkyl alkoxy surfactants are the C₉-C₁₅ primary alcohol ethoxylates containing 3-12 moles of ethylene oxide per mole of alcohol, particularly the C₁₂-C₁₅ primary alcohols containing 5-10 moles of ethylene oxide per mole of alcohol.

Examples of commercially available surfactants of this type include: Tergitol™ 15-S-9 (the condensation product of C₁₁-C₁₅ linear alcohol with 9 moles ethylene oxide) and Tergitol™ 24-L-6 NMW (the condensation product of C₁₂-C₁₄ primary alcohol with 6 moles ethylene oxide with a narrow molecular weight distribution), both marketed by Union Carbide Corporation; Neodol™ 45-9 (the condensation product of C₁₄-C₁₅ linear alcohol with 9 moles of ethylene oxide), Neodol™ 23-3 (the condensation product of C₁₂-C₁₃ linear alcohol with 3 moles of ethylene oxide), Neodol™ 45-7 (the condensation product of C₁₄-C₁₅ linear alcohol with 7 moles of ethylene oxide) and Neodol™ 45-5 (the condensation product of C₁₄-C₁₅ linear alcohol with 5 moles of ethylene oxide) marketed by Shell Chemical Company; Kyro™ EOB (the condensation product of C₁₃-C₁₅ alcohol with 9 moles ethylene oxide), marketed by The Procter & Gamble Company; and Genapol LA O3O or O5O (the condensation product of C₁₂-C₁₄ alcohol with 3 or 5 moles of ethylene oxide) marketed by Hoechst. Condensates with propylene oxide and butylene oxides may also be used.

In one embodiment, the weight ratio of mid-branched primary alkyl sulfate surfactant to additional surfactant is from about 5:1 to about 1:5, alternatively from about 2:1 to about 1:2, alternatively the ratio is about 1:1. In another embodiment, the composition contains an AES surfactant and the weight ratio of AES surfactant to mid-branched primary alkyl sulfate surfactant is about 1:1.

HLAS Surfactants

The compositions of the present invention contain less than 3%, by weight of the composition, of HLAS surfactants. The compositions of the present invention are preferably substantially free of HLAS surfactants. As used herein “substantially free of” means that the HLAS surfactant is not specifically added to the composition of the present invention, but may be present in trace amounts as an impurity in another component in the composition. In one embodiment, the composition is completely free of any measurable quantity of HLAS surfactant.

As used herein, “HLAS surfactant” refers to alkyl benzene sulfonic acids and alkali metal salts of C10-16 alkyl benzene sulfonic acids, preferably C11-14 alkyl benzene sulfonic acids. Preferably the alkali group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. An example of an HLAS surfactant is sodium linear alkyl benzene sulfonates, commonly referenced as “NaLAS.”

Sodium Formate

Without being limited by theory, it is believed that by utilizing a selected amount of sodium formate in combination with the other components of the current invention, that a desirable viscosity may be reached, without unduly affecting the cleaning performance and stability of the overall composition. The compositions of the present invention contain from about 0.1% to about 1.5%, by weight of the composition, of sodium formate

Viscosity

The compositions of the present invention will typically have a viscosity which ranges from about 100 to 600 cps, alternatively from about 150 to 400 cps. In one embodiment, the compositions of the present invention will have a viscosity of from about 300 to about 400 centipoise. Viscosity is measured with a Brookfield LVDV-II+ viscometer apparatus using a #21 spindle.

Hydrophilic Index

The compositions of the present invention may have a hydrophilic index of from about 7.0 to about 10.5. The hydrophilic index gives an indication of the hydrophobicity of the formulation. Without being limited by theory, it is believed that selecting the components of the present in the appropriate ranges to obtain a hydrophilic index of from about 7.0 to about 10.5 ensures that the compositions herein are capable of providing improved cleaning, viscosity and stability. Again, without being limited by theory, it is believed that if the formulation is not hydrophobic enough, that the formulation will have poor cleaning capability. Alternatively, if the formulation is too hydrophobic, it will be difficult to maintain stability and viscosity.

The Hydrophilic Index for a system of mixed surfactants can be calculated as follows:
HI_{C}=Σ_{y} (weight % of surfactant y in the surfactant system)×(HI_{S} for surfactant y). (1)
HI_{S} is calculated for each of the individual surfactants in the mixture as follows:
HI_{S}=20×(the molecular weight of the head group)/(the molecular weight the surfactant). (2)

In the case of ionic surfactants, the HIₛ in equation (2) are calculated for the surfactant ions and the weight percents in equation (1) are for the corresponding surfactant ions.

Optional Ingredients

APA

In one embodiment, the compositions of the present invention are substantially free of APA. As used herein, “substantially free of” means that the HLAS surfactant is not specifically added to the composition of the present invention, but may be present in trace amounts as an impurity in another component in the composition. As used herein “APA” refers to C8-C10 amido propyl dimethyl amine. In one embodiment, the compositions are completely free of any measurable quantity of APA.

Builder

In one embodiment, the compositions of the present invention contain less than about 2.5% builder. As used herein, “builder” refers to polycarboxylate compounds, including water-soluble nonsurfactant dicarboxylates and tricarboxylates. More typically builder polycarboxylates have a plurality of carboxylate groups, in one embodiment, at least 3 carboxylates. Carboxylate builders can be formulated in acid, partially neutral, neutral or overbased form. When in salt form, alkali metals, such as sodium, potassium, and lithium, or alkanolammonium salts are often used. Polycarboxylate builders include the ether polycarboxylates, such as oxydisuccinate, see Berg, U.S. Pat. No. 3,128,287, Apr. 7, 1964, and Lamberti et al, U.S. Pat. No. 3,635,830, Jan. 18, 1972; “TMS/TDS” builders of U.S. Pat. No. 4,663,071, Bush et al, May 5, 1987; and other ether carboxylates including cyclic and alicyclic compounds, such as those described in U.S. Pat. Nos. 3,923,679; 3,835,163; 4,158,635; 4,120,874 and 4,102,903.

Other builders are the ether hydroxypolycarboxylates, copolymers of maleic anhydride with ethylene or vinyl methyl ether; 1,3,5-trihydroxy benzene-2,4,6-trisulphonic acid; carboxymethyloxysuccinic acid; the various alkali metal, ammonium and substituted ammonium salts of polyacetic acids such as ethylenediamine tetraacetic acid and nitrilotriacetic acid; as well as mellitic acid, succinic acid, polymaleic acid, benzene 1,3,5-tricarboxylic acid, carboxymethyloxysuccinic acid, and soluble salts thereof.

Citrates, e.g., citric acid and soluble salts thereof are also included as carboxylate builders e.g., for heavy duty liquid detergents. Oxydisuccinates are also used as builders.

Other Optional Additives And Usage

The liquid laundry detergent compositions of the present invention will generally contain an aqueous component, generally containing a high level of water. While other types of water-miscible liquids, such as alkanols, diols, other polyols, ethers, amines, and the like, have been conventionally been added to liquid detergent compositions as co-solvents or stabilizers, for purposes of the present invention, the utilization of such water-miscible liquids should be minimized to hold down composition cost. Accordingly, the aqueous component of the liquid detergent products herein will generally comprise water present in concentrations ranging from about 5% to about 90%, more preferably from about 20% to about 70%, by weight of the composition.

The detergent compositions of the present invention can also include any number of additional optional ingredients. These include conventional laundry detergent composition components such as enzymes, enzyme stabilizers (such as propylene glycol, boric acid and/or borax), suds suppressors, soil suspending agents, soil release agents, other fabric care benefit agents, pH adjusting agents, chelating agents, viscosity modifiers, polymers, silicones, softening compounds, smectite clays, solvents, hydrotropes and phase stabilizers, structuring agents, dye transfer inhibiting agents, optical brighteners, perfumes, hueing dyes, and coloring agents. The various optional detergent composition ingredients, if present in the compositions herein, should be utilized at concentrations conventionally employed to bring about their desired contribution to the composition or the laundering operation. Frequently, the total amount of such optional detergent composition ingredients can range from about 0.01% to about 50%, more preferably from about 1% to about 30%, by weight of the composition.

The liquid detergent compositions herein are in the form of an aqueous solution or uniform dispersion or suspension of surfactant and certain optional other ingredients, some of which may normally be in solid form, that have been combined with the normally liquid components of the composition, the aqueous liquid carrier, and any other normally liquid optional ingredients. Such a solution, dispersion or suspension will be acceptably phase stable. The liquid detergent compositions herein can be prepared by combining the components thereof in any convenient order and by mixing, e.g., agitating, the resulting component combination to form a phase stable liquid detergent composition.

In a preferred process for preparing such compositions, a liquid matrix is formed containing at least a major proportion, and preferably substantially all, of the liquid components, e.g., surfactant, liquid carriers and other optional liquid components, with the liquid components being thoroughly admixed by imparting shear agitation to this liquid combination. For example, rapid stirring with a mechanical stirrer may usefully be employed. While shear agitation is maintained, substantially all of the anionic surfactants and the solid form ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme prills, are incorporated. As a variation of the composition preparation procedure hereinbefore described, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

The compositions of this invention, prepared as hereinbefore described, can be used to form aqueous washing solutions for use in the laundering of fabrics. Generally, an effective amount of such compositions is added to water, preferably in a conventional fabric laundering automatic washing machine, to form such aqueous laundering solutions. The aqueous washing solution so formed is then contacted, preferably under agitation, with the fabrics to be laundered therewith. An effective amount of the liquid detergent compositions herein added to water to form aqueous laundering solutions can comprise amounts sufficient to form from about 500 to 7,000 ppm of composition in aqueous washing solution. More preferably, from about 1,000 to 3,000 ppm of the detergent compositions herein will be provided in aqueous washing solution. The present detergent compositions have been found to exhibit good cleaning efficiency during a laundry wash cycle, especially a cold water (about 10° C. to about 18° C.) laundry cycle.

### EXAMPLES

The following examples illustrate the compositions of the present invention but are not necessarily meant to limit or otherwise define the scope of the invention herein. Terminology utilized in the examples is defined as follows:

| | |
|---|---|
| MBASx | Mid-Chain branched primary alkyl |
| | (average total carbons = x) sulfate |
| Fatty acid (C12/14) | C12-C14 fatty acid |
| Fatty Acid (TPK) | Topped palm kernel fatty acid |
| Fatty acid (RPS) | Rapeseed fatty acid |
| DTPA | Diethylene Triamine Pentaacetic Acid |
| Sodium Formate | HCOONa |
| Calcium Formate | (HCOO)2Ca |

### Examples 1a-1f

The following examples 1a-1f exemplify liquid laundry detergent compositions according to the present invention. These compositions exhibit good stability, desirable viscosity and good cleaning capability. The examples are prepared by traditional methods disclosed above or other similar methods known to one of ordinary skill in the art.

| | 1a | 1b | 1c |
|---|---|---|---|
| | Hydrophilic Index | | |
| | 7.5 | 8.0 | 9.6 |
| Ingredient | wt % | wt % | wt % |
| MBAS (16.5 ave. total carbon) | 10 | 6 | 1.5 |
| sodium alkyl alkoxy sulfate | 7 | 8 | 8 |
| alkyl alkoxy | 0.6 | 0.41 | 1.2 |
| citric acid | 2.1 | 1.8 | 1.0 |
| fatty acid | 1.2 | 1.0 | 0 |
| enzyme | 1.0 | 1.2 | 0.28 |
| borax | 1.4 | 1.4 | 1 |
| Calcium Formate | 0.08 | 0.08 | 0.09 |
| Sodium formate | 0.8 | 0.48 | 0.5 |
| Amine ethoxylate polymers | 2.3 | 2.0 | 0.4 |
| DTPA¹ | 0.6 | 0.35 | 0.3 |
| fluorescent whitening agent | 0.15 | 0.1 | 0.04 |
| Solvent | 7.2 | 6.0 | 5.5 |
| ethanolamine | 1.4 | 1.2 | 0.9 |
| sodium hydroxide | 3.5 | 2.6 | 1.0 |
| perfume | 0.25 | 0.28 | 0.25 |
| water | balance | balance | balance |
| | 100.0% | 100.0% | 100.0% |

¹diethylenetriaminepentaacetic acid, sodium salt

| | 1d | 1e | 1f |
|---|---|---|---|
| | Hydrophilic Index | | |
| | 10.3 | 9.6 | 8.5 |
| Ingredient | wt % | wt % | wt % |
| MBAS (16.5 ave. total carbon) | 1.5 | 1.5 | 3 |
| sodium alkyl alkoxy sulfate | 8 | 8 | 5 |
| alkyl alkoxy | 5 | 1.2 | 0.4 |
| citric acid | 1.2 | 0 | 0.5 |
| fatty acid | 1.0 | 0 | 0 |
| enzyme | 0.6 | 0.4 | 1.5 |
| borax | 1.0 | 1 | 1 |
| Calcium Formate | 0.08 | 0.09 | 0.09 |
| Sodium formate | 0.5 | 0.5 | 0.8 |
| Amine ethoxylate polymers | 1.8 | 0.4 | 0.5 |
| DTPA¹ | 0.3 | 0.3 | 0.3 |
| fluorescent whitening agent | 0.04 | 0.1 | 0.10 |
| Solvent | 4.5 | 5.0 | 4.8 |
| ethanolamine | 0.85 | 0.85 | 1.0 |
| sodium hydroxide | 1.3 | 1.0 | 1.2 |
| perfume | 0.27 | 0.25 | 0.25 |
| water | balance | balance | balance |
| | 100.0% | 100.0% | 100.0% |

¹diethylenetriaminepentaacetic acid, sodium salt

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition having improved stability and viscosity, wherein the composition comprises:
a) from about 5% to about 20%, by weight of the composition, of a surfactant system, wherein the surfactant system comprises;
i) from about 0.5% to about 15%, by weight of the composition, of a mid-branched primary alkyl sulfate surfactant having an average of from about 14 to about 17 total carbons;
ii) at least about 0.1%, by weight of the composition, of an additional surfactant selected from alkyl alkoxy sulfate surfactants, alkyl alkoxy surfactants, and mixtures thereof; and
b) from about 0.1% to about 1.5%, by weight of the composition, of sodium formate;
wherein the composition comprises less than about 3% of HLAS surfactants.

2. A laundry detergent composition according to claim 1 wherein the composition comprises from about 0.1% to about 10%, by weight of the composition, of alkyl alkoxy surfactant.

3. A laundry detergent composition according to claim 1 wherein the composition comprises from about 0.5% to about 15%, by weight of the composition of an alkyl alkoxy sulfate surfactant.

4. A laundry detergent composition according to claim 3 wherein the composition is substantially free of APA.

5. A laundry detergent composition according to claim 3 wherein the composition further comprises less than about 2.5% builders.

6. A liquid laundry detergent composition according to claim 3 wherein the composition comprises less than about 2.5% citric acid.

7. A liquid laundry detergent composition according to claim 1 wherein the composition has a viscosity of from about 300 to about 400 centipoise.

8. A liquid laundry detergent composition according to claim 1 wherein the composition has a hydrophilic index of from about 7 to about 10.5.

9. A liquid laundry detergent composition according to claim 1 wherein the composition further comprises an aqueous component.

10. A liquid laundry detergent composition according to claim 9 wherein the aqueous component comprises from about 5% to about 90%, by weight of the composition, of water.

11. A liquid laundry detergent composition according to claim 10 wherein the mid-branched primary alkyl sulfate surfactant is selected from: 3-methyl pentadecanol sulfate, 4-methyl pentadecanol sulfate, 5-methyl pentadecanol sulfate, 6-methyl pentadecanol sulfate, 7-methyl pentadecanol sulfate, 8-methyl pentadecanol sulfate, 9-methyl pentadecanol sulfate, 10-methyl pentadecanol sulfate, 11-methyl pentadecanol sulfate, 12-methyl pentadecanol sulfate, 13-methyl pentadecanol sulfate, 3-methyl hexadecanol sulfate, 4-methyl hexadecanol sulfate, 5-methyl hexadecanol sulfate, 6-methyl hexadecanol sulfate, 7-methyl hexadecanol sulfate, 8-methyl hexadecanol sulfate, 9-methyl hexadecanol sulfate, 10-methyl hexadecanol sulfate, 11-methyl hexadecanol sulfate, 12-methyl hexadecanol sulfate, 13-methyl hexadecanol sulfate, 14-methyl hexadecanol sulfate, 2,3-methyl tetradecanol sulfate, 2,4-methyl tetradecanol sulfate, 2,5-methyl tetradecanol sulfate, 2,6-methyl tetradecanol sulfate, 2,7-methyl tetradecanol sulfate, 2,8-methyl tetradecanol sulfate, 2,9-methyl tetradecanol sulfate, 2,10-methyl tetradecanol sulfate, 2,11-methyl tetradecanol sulfate, 2,12-methyl tetradecanol sulfate, 2,3-methyl pentadecanol sulfate, 2,4-methyl pentadecanol sulfate, 2,5-methyl pentadecanol sulfate, 2,6-methyl pentadecanol sulfate, 2,7-methyl pentadecanol sulfate, 2,8-methyl pentadecanol sulfate, 2,9-methyl pentadecanol sulfate, 2,10-methyl pentadecanol sulfate, 2,11-methyl pentadecanol sulfate, 2,12-methyl pentadecanol sulfate, 2,13-methyl pentadecanol sulfate, and mixtures thereof.

12. A liquid laundry detergent composition according to claim 1 wherein the mid-branched primary alkyl sulfate surfactant is selected from:
5-methylpentadecylsulfate having the formula: 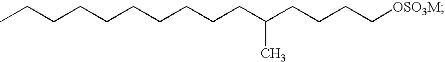
6-methylpentadecylsulfate having the formula 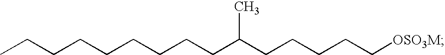
7-methylpentadecylsulfate having the formula 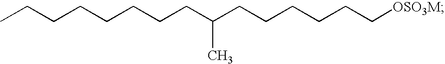
8-methylpentadecylsulfate having the formula 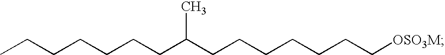
9-methylpentadecylsulfate having the formula 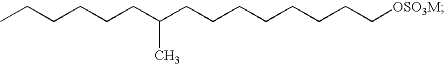
10-methylpentadecylsulfate having the formula 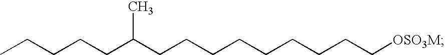
2,5-dimethylpentadecylsulfate having the formula: 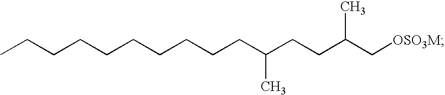
2,6-dimethylpentadecylsulfate having the formula 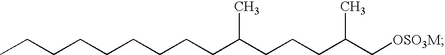
2,7-dimethylpentadecylsulfate having the formula 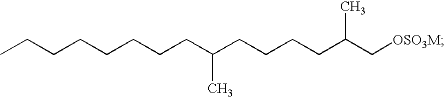
2,8-dimethylpentadecylsulfate having the formula 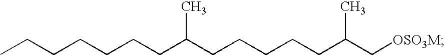
2,9-dimethylpentadecylsulfate having the formula 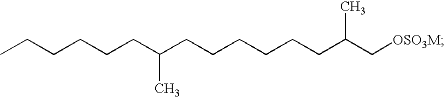
2,10-dimethylpentadecylsulfate having the formula 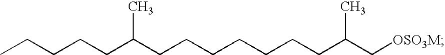
and mixtures thereof; wherein M is sodium.

13. A liquid laundry detergent composition having improved stability and viscosity, wherein the composition comprises:
a) from about 5% to about 20%, by weight of the composition, of a surfactant system, wherein the surfactant system comprises;
i) from about 0.5% to about 15%, by weight of the composition, of a mid-branched primary alkyl sulfate surfactant selected from 3-methyl pentadecanol sulfate, 4-methyl pentadecanol sulfate, 5-methyl pentadecanol sulfate, 6-methyl pentadecanol sulfate, 7-methyl pentadecanol sulfate, 8-methyl pentadecanol sulfate, 9-methyl pentadecanol sulfate, 10-methyl pentadecanol sulfate, 11-methyl pentadecanol sulfate, 12-methyl pentadecanol sulfate, 13-methyl pentadecanol sulfate, 3-methyl hexadecanol sulfate, 4-methyl hexadecanol sulfate, 5-methyl hexadecanol sulfate, 6-methyl hexadecanol sulfate, 7-methyl hexadecanol sulfate, 8-methyl hexadecanol sulfate, 9-methyl hexadecanol sulfate, 10-methyl hexadecanol sulfate, 11-methyl hexadecanol sulfate, 12-methyl hexadecanol sulfate, 13-methyl hexadecanol sulfate, 14-methyl hexadecanol sulfate, 2,3-methyl tetradecanol sulfate, 2,4-methyl tetradecanol sulfate, 2,5-methyl tetradecanol sulfate, 2,6-methyl tetradecanol sulfate, 2,7-methyl tetradecanol sulfate, 2,8-methyl tetradecanol sulfate, 2,9-methyl tetradecanol sulfate, 2,10-methyl tetradecanol sulfate, 2,11-methyl tetradecanol sulfate, 2,12-methyl tetradecanol sulfate, 2,3-methyl pentadecanol sulfate, 2,4-methyl pentadecanol sulfate, 2,5-methyl pentadecanol sulfate, 2,6-methyl pentadecanol sulfate, 2,7-methyl pentadecanol sulfate, 2,8-methyl pentadecanol sulfate, 2,9-methyl pentadecanol sulfate, 2,10-methyl pentadecanol sulfate, 2,11-methyl pentadecanol sulfate, 2,12-methyl pentadecanol sulfate, 2,13-methyl pentadecanol sulfate, and mixtures thereof;
ii) at least about 0.1%, by weight of the composition, of an additional surfactant selected from alkyl alkoxy sulfate surfactants, alkyl alkoxy surfactants, and mixtures thereof; and
c) from about 0.1% to about 1.5%, by weight of the composition, of sodium formate;
wherein the composition is substantially free of HLAS surfactants.

14. A laundry detergent composition according to claim 13 wherein the mid-branched primary alkyl sulfate surfactant is selected from:
5-methylpentadecylsulfate having the formula: 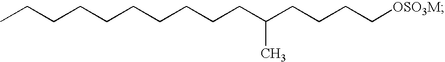
6-methylpentadecylsulfate having the formula 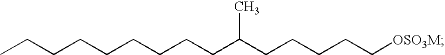
7-methylpentadecylsulfate having the formula 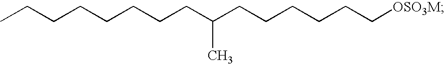
8-methylpentadecylsulfate having the formula 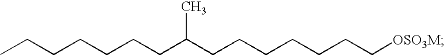
9-methylpentadecylsulfate having the formula 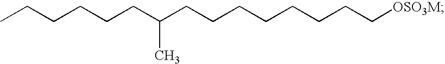
10-methylpentadecylsulfate having the formula 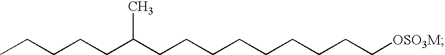
2,5-dimethylpentadecylsulfate having the formula: 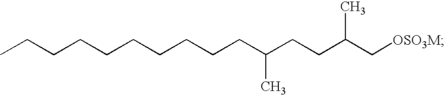
2,6-dimethylpentadecylsulfate having the formula 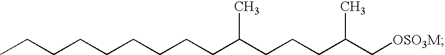
2,7-dimethylpentadecylsulfate having the formula 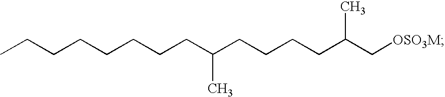
2,8-dimethylpentadecylsulfate having the formula 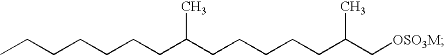
2,9-dimethylpentadecylsulfate having the formula 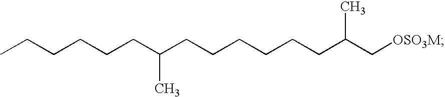
2,10-dimethylpentadecylsulfate having the formula 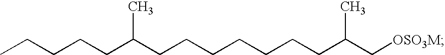
and mixtures thereof; wherein M is sodium

15. A laundry detergent composition according to claim 13 wherein the composition comprises from about 0.1% to about 10%, by weight of the composition, of alkyl alkoxy surfactant.

16. A laundry detergent composition according to claim 13 wherein the composition comprises from about 0.5% to about 15%, by weight of the composition of an alkyl alkoxy sulfate surfactant.

17. A laundry detergent composition according to claim 13 wherein the composition comprises from about from about 0.1% to about 10%, by weight of the composition, of alkyl alkoxy surfactant and from about 0.5% to about 15%, by weight of the composition, of an alkyl alkoxy sulfate surfactant.

18. A laundry detergent composition according to claim 13 wherein the composition is substantially free of APA;

19. A liquid laundry detergent composition according to claim 13 wherein the composition comprises less than about 2.5% citric acid.

20. A liquid laundry detergent composition according to claim 19 wherein the composition has a viscosity of from about 300 to about 400 centipoise.

21. A liquid laundry detergent composition according to claim 13 wherein the composition has a hydrophilic index of from about 7 to about 10.5.
